(19) United States
(12) Patent Application Publication
(10) Pub. No.: US 2026/0331572 A1
(43) Pub. Date: Oct. 22, 2026

(54) ALL-SOLID-STATE BATTERY

(71) Applicant: HONDA MOTOR CO., LTD., Tokyo (JP)

(72) Inventors: Mitsuhiro Sada, Wako-shi (JP); Kiyoshi Tanaami, Wako-shi (JP); Shoji Takahashi, Wako-shi (JP)

(21) Appl. No.: 19/549,029

(22) Filed: Feb. 25, 2026

(30) Foreign Application Priority Data
Mar. 25, 2025 (JP) 2025-049372

(51) Int. Cl. H01M 10/0562; H01M 10/0525; H01M 10/0585; H01M 50/463; H01M 50/489

(52) U.S. Cl. CPC H01M 10/0562; H01M 10/0525; H01M 10/0585; H01M 50/463; H01M 50/489

(57) ABSTRACT

There is provided an all-solid-state battery including a positive electrode layer, a solid electrolyte layer, and a negative electrode layer, wherein the solid electrolyte layer contains solid electrolyte particles having a particle size of 1 μm or less at least at an end in a direction perpendicular to the direction in which the positive electrode layer, the solid electrolyte layer and the negative electrode layer are laminated, and the solid electrolyte layer has a density of 1.90 g/cm³ or more at least at the end in the direction perpendicular to the lamination direction.

### CROSS-REFERENCE TO RELATED APPLICATION

Priority is claimed on Japanese Patent Application No. 2025-049372, filed Mar. 25, 2025, the content of which is incorporated herein by reference.

### BACKGROUND OF THE INVENTION

### Field of the Invention

The present invention relates to an all-solid-state battery.

### Description of Related Art

All-solid-state lithium-ion secondary batteries containing a solid electrolyte mainly composed of an ion conductor that can conduct ions in a solid state do not have problems caused by flammable organic electrolytic solutions as in liquid lithium-ion secondary batteries. In addition, when a high-potential and high-capacity positive electrode material, and a high-capacity negative electrode material are used in all-solid-state lithium-ion secondary batteries, the output density and energy density of the batteries can be significantly improved.

Conventionally, as one type of all-solid-state lithium-ion secondary battery, there is a so-called lithium deposition type in which lithium metal is deposited on a negative electrode current collector during a charging process. With such a configuration, dendrites may grow on the negative electrode current collector during charging, leading to a decrease in the battery capacity or the occurrence of short-circuiting.

There is a devised lithium secondary battery in which, in order to inhibit the deposition of lithium on a negative electrode current collector and the growth of dendrites during charging, on at least a part of a region of the main surface of a solid electrolyte layer that faces the negative electrode current collector where a positive electrode active material layer faces the negative electrode current collector, an ion-conducting reaction inhibition layer having lithium ion conductivity and inhibiting a reaction between lithium metal and a solid electrolyte is provided, the solid electrolyte layer extends to the end in the planar direction on the side of a positive electrode of the solid electrolyte layer, an ion permeation inhibition layer that inhibits permeation of lithium ions is provided at the end in the planar direction on the side of a negative electrode of the solid electrolyte layer, and at least a part of the ion permeation inhibition layer overlaps the ion-conducting reaction inhibition layer in a plan view (for example, refer to PCT International Publication No. WO2023/218218).

### SUMMARY OF THE INVENTION

When all-solid-state lithium-ion secondary batteries are produced, cracks may occur on the sides of the solid electrolyte layer. The ion conductivity decreases on the sides of the solid electrolyte layer where cracks occur, resulting in poor rate characteristics of the all-solid-state lithium-ion secondary batteries. In addition, the sides of the solid electrolyte layer where cracks occur are parts where lithium is likely to deposit. In PCT International Publication No. WO2023/218218, the growth of dendrites is inhibited, but there is room for improvement in minimizing the occurrence of cracks on the sides of the solid electrolyte layer.

An aspect of the present invention provides an all-solid-state battery in which the occurrence of cracks on the sides of a solid electrolyte layer is minimized and the deposition of lithium on the sides of the solid electrolyte layer is inhibited. The aspect of the present invention contributes to stabilizing battery performance and improving energy efficiency.

The present invention includes the following aspects.
[1] An all-solid-state battery including a positive electrode layer, a solid electrolyte layer, and a negative electrode layer,
wherein the solid electrolyte layer contains solid electrolyte particles having a particle size of 1 μm or less at least at an end in a direction perpendicular to the direction in which the positive electrode layer, the solid electrolyte layer and the negative electrode layer are laminated, and the solid electrolyte layer has a density of 1.90 g/cm³ or more at least at the end in the direction perpendicular to the lamination direction.

According to the above aspect, in the solid electrolyte layer, at least at the end in the direction perpendicular to the direction in which the positive electrode layer, the solid electrolyte layer and the negative electrode layer are laminated, since the contract area between the solid electrolyte particles increases, the ion conductivity of the solid electrolyte layer is improved.
[2] The all-solid-state battery according to [1] or [2], wherein the solid electrolyte layer does not contain solid electrolyte particles having a particle size of more than 1 μm at least at the end in the direction perpendicular to the lamination direction.

According to the above aspect, the solid electrolyte particles contained in the solid electrolyte layer are only fine particles, and thus ion conductivity of the solid electrolyte layer is further improved.
[3] The all-solid-state battery according to [1] or [2], wherein the solid electrolyte layer contains a binder, and a content of the binder with respect to a total weight of the solid electrolyte layer is 3 wt % or more.

According to the above aspect, when the density of the solid electrolyte layer is improved, the ion conductivity of the solid electrolyte layer is further improved. In addition, the mechanical strength of the solid electrolyte layer is improved.
[4] The all-solid-state battery according to any one of [1] to [3], wherein the solid electrolyte layer has a positive electrode facing region that faces the positive electrode layer at least at the end in the direction perpendicular to the lamination direction, and in the solid electrolyte layer, a specific surface area of the positive electrode facing region on a side closer to the positive electrode layer is 548m²/g or more.

According to the above aspect, even if the positive electrode layer is made denser (has a higher density) than the solid electrolyte layer, the bondability of the solid electrolyte layer to the positive electrode layer is improved.
[5] The all-solid-state battery according to any one of [1] to [4],
   wherein the solid electrolyte layer has a positive electrode facing region that faces the positive electrode layer at least at the end in the direction perpendicular to the lamination direction,
   the positive electrode layer has a tapered region where a thickness decreases toward the outer circumferential side of the positive electrode layer at the end in the direction perpendicular to the lamination direction, and
   the positive electrode facing region faces the tapered region in the lamination direction.

According to the above aspect, the solid electrolyte layer containing solid electrolyte particles having a small particle size faces the tapered region of the positive electrode layer where the thickness is not uniform, and the formation of gaps between the positive electrode layer and the solid electrolyte layer can be inhibited. As a result, in the positive electrode layer and the solid electrolyte layer, a decrease in ion conductivity can be minimized.
[6] The all-solid-state battery according to any one of [1] to [5],
   wherein the all-solid-state battery utilizes a lithium deposition and dissolution reaction,
   the all-solid-state battery further includes an intermediate layer containing particles having a particle size of 0.5 μm or less between the solid electrolyte layer and the negative electrode layer, and
   the solid electrolyte layer has an intermediate layer facing region that faces the intermediate layer at least at the end in the direction perpendicular to the lamination direction.

According to the above aspect, the thickness of the intermediate layer is thin, the particle size of the particles is also small, but the density of the solid electrolyte layer is high, and thus the structure of the intermediate layer is stable.
[7] The all-solid-state battery according to any one of [1] to [6], wherein the solid electrolyte layer has an extension part that extends beyond the positive electrode layer and the negative electrode layer in the direction perpendicular to the lamination direction.

According to the above aspect, since the high-density solid electrolyte layer extends outward beyond the positive electrode layer and the negative electrode layer, the insulating properties of the positive electrode layer and the negative electrode layer due to the solid electrolyte layer are improved.
[8] The all-solid-state battery according to any one of [1] to [7], wherein the solid electrolyte layer has a density of 1.90 g/cm³ or more at an outer circumferential end.

According to the above aspect, the solid electrolyte layer is formed over the entire outer circumference of the positive electrode layer and the negative electrode layer (in both the long side direction and the short side direction of the positive electrode layer and the negative electrode layer).
[9] The all-solid-state battery according to [9],
wherein the solid electrolyte layer has a smaller length on one outer circumferential side in a direction perpendicular to the lamination direction than on other outer circumferential side in the direction perpendicular to the lamination direction, and
   the distance over a region on the other outer circumferential side where the density of the solid electrolyte layer is 1.90 g/cm³ or more is longer than the distance over a region on the one outer circumferential side where the density of the solid electrolyte layer is 1.90 g/cm³ or more.

According to the above aspect, the solid electrolyte layer is easily formed over the entire outer circumference of the positive electrode layer and the negative electrode layer (in both the long side direction and the short side direction of the positive electrode layer and the negative electrode layer).

[10] The all-solid-state battery according to any one of [1] to [9], wherein the solid electrolyte layer has an ion conductivity of 1.00 mS/cm or more.

According to the above aspect, the solid electrolyte layer has excellent ion conductivity.

An aspect of the present invention provides an all-solid-state battery in which the occurrence of cracks on the sides of a solid electrolyte layer is minimized and the deposition of lithium on the sides of the solid electrolyte layer is inhibited.

### BRIEF DESCRIPTION OF THE DRAWINGS

FIG. 1 is a plan view showing an all-solid-state battery according to one embodiment of the present invention.

FIG. 2 is a cross-sectional view taken along the line A-A in FIG. 1, showing the all-solid-state battery according to one embodiment of the present invention.

FIG. 3 is a plan view showing the all-solid-state battery according to one embodiment of the present invention.

FIG. 4 is a scanning electron microscope (SEM) image of a cross section of a solid electrolyte layer obtained in Example 1 in the thickness direction.

FIG. 5 is a scanning electron microscope (SEM) image of a cross section of a solid electrolyte layer obtained in Example 2 in the thickness direction.

FIG. 6 is a scanning electron microscope (SEM) image of a cross section of a solid electrolyte layer obtained in a comparative example in the thickness direction.

### DETAILED DESCRIPTION OF THE INVENTION

Hereinafter, embodiments of the present invention will be described in detail with reference to the drawings.

### All-Solid-State Battery

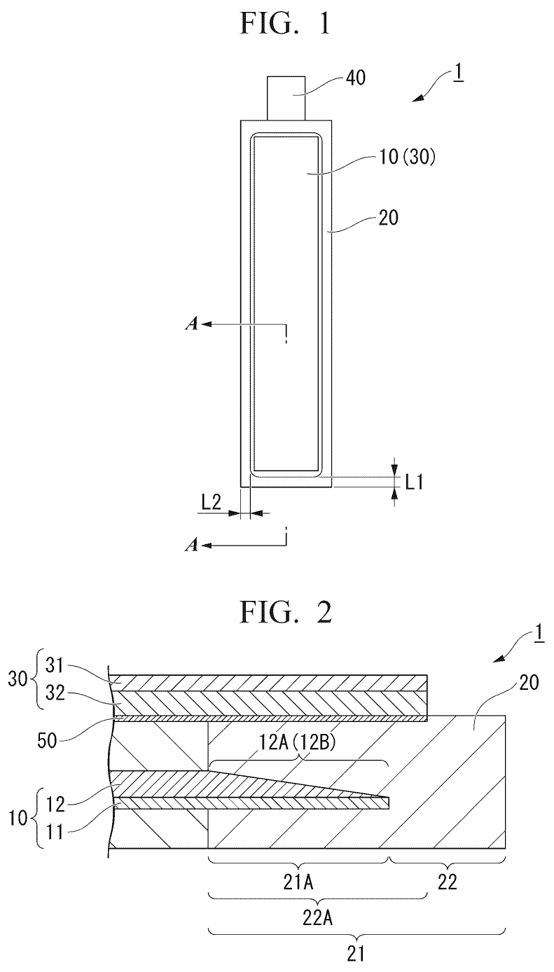

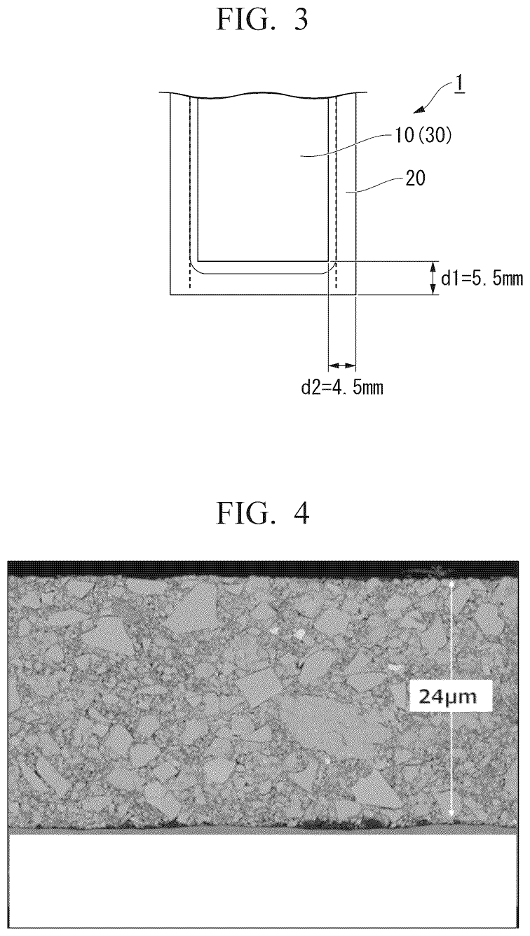

FIG. 1 is a plan view showing an all-solid-state battery according to one embodiment of the present invention. FIG. 2 shows the all-solid-state battery according to one embodiment of the present invention, and is a cross-sectional view taken along the line A-A in FIG. 1. FIG. 3 is a plan view showing the all-solid-state battery according to one embodiment of the present invention.

As shown in FIG. 1 and FIG. 2, an all-solid-state battery 1 of the present embodiment includes a positive electrode layer 10, a solid electrolyte layer 20, and a negative electrode layer 30. In addition, the all-solid-state battery 1 of the present embodiment includes a current collecting tab 40 connected to a positive electrode current collector 11 constituting the positive electrode layer 10 and a negative electrode current collector 31 constituting the negative electrode layer 30. The positive electrode layer 10 includes the positive electrode current collector 11 and a positive electrode active material layer 12. The negative electrode layer 30 includes the negative electrode current collector 31 and a negative electrode active material layer 32.

The thickness of the solid electrolyte layer 20 is preferably 200 μm or more and 300 μm or less, more preferably 100 μm or more and 150 μm or less, and still more preferably 15 μm or more and 20 μm or less.

The solid electrolyte layer 20 contains solid electrolyte particles having a particle size of 1 μm or less at least at an end 21 in a direction perpendicular to the direction in which the positive electrode layer 10, the solid electrolyte layer 20 and the negative electrode layer 30 are laminated. Here, the solid electrolyte layer 20 may contain solid electrolyte particles having a particle size of 1 μm or less throughout the entire layer. When the particle size of the solid electrolyte particles is 1 μm or less, since the contract area between the solid electrolyte particles increases, the ion conductivity of the solid electrolyte layer is improved.

The solid electrolyte layer 20 preferably does not contain solid electrolyte particles having a particle size of more than 1 μm at least at the end 21 in a direction perpendicular to the direction in which the positive electrode layer 10, the solid electrolyte layer 20 and the negative electrode layer 30 are laminated. Accordingly, the solid electrolyte particles contained in the solid electrolyte layer 20 are only fine particles, and thus the ion conductivity of the solid electrolyte layer 20 is further improved.

The particle size of the solid electrolyte particles can be measured by particle size distribution measurement.

The solid electrolyte layer 20 has a density of 1.90 g/cm³ or more at least at the end 21 in a direction perpendicular to the direction in which the positive electrode layer 10, the solid electrolyte layer 20 and the negative electrode layer 30 are laminated. Here, the density may be 1.90 g/cm³ or more throughout the solid electrolyte layer 20. When the density of the solid electrolyte layer 20 is 1.90 g/cm³ or more, since the contract area between the solid electrolyte particles increases, the ion conductivity of the solid electrolyte layer 20 is improved. In addition, the mechanical strength (for example, tensile strength) of the solid electrolyte layer 20 is improved.

The density of the solid electrolyte layer 20 can be measured by a BET method.

The solid electrolyte layer 20 preferably contains a binder. The content of the binder with respect to the total weight (100 wt %) of the solid electrolyte layer 20 is preferably 3 wt % or more, more preferably 20 wt % or more, and still more preferably 30 wt % or more. When the content of the binder is equal to or larger than the lower limit value, the density of the solid electrolyte layer 20 is improved, and thus the ion conductivity of the solid electrolyte layer 20 is further improved. In addition, the mechanical strength of the solid electrolyte layer 20 is improved.

The content of the binder with respect to the total weight (100 wt %) of the solid electrolyte layer 20 may be 3 wt % or less, 1 wt % or less, or 0.1 wt % or less.

The solid electrolyte layer 20 preferably has a positive electrode facing region 21A facing the positive electrode layer 10 at least at the end 21 in a direction perpendicular to the direction in which the positive electrode layer 10, the solid electrolyte layer 20 and the negative electrode layer 30 are laminated. In the solid electrolyte layer 20, the specific surface area of the positive electrode facing region 21A on the side of the positive electrode layer 10 is preferably 1,025 m²/g or more, more preferably 1,184 m²/g or more, and still more preferably 1,343 m²/g or more. When the specific surface area of the solid electrolyte layer 20 in the positive electrode facing region 21A is equal to or larger than the lower limit value, even if the positive electrode layer 10 is made denser (has a higher density) than the solid electrolyte layer 20, the bondability of the solid electrolyte layer 20 to the positive electrode layer 10 is improved. In the solid electrolyte layer 20, the specific surface area of the positive electrode facing region 21A on the side of the positive electrode layer 10 may be 1,343 m²/g or less, 1,000 m²/g or less, or 500 m²/g or less.

A specific surface area of the solid electrolyte layer 20 in the positive electrode facing region 21A can be measured by a BET method.

The solid electrolyte layer 20 preferably has the positive electrode facing region 21A facing the positive electrode layer 10 at least at the end 21 in a direction perpendicular to the direction in which the positive electrode layer 10, the solid electrolyte layer 20 and the negative electrode layer 30 are laminated. The positive electrode layer 10 preferably has a tapered region 12B where the thickness decreases toward the outer circumferential side of the positive electrode layer 10 at an end in a direction perpendicular to the lamination direction, in other words, at an end 12A of the positive electrode active material layer 12. The positive electrode facing region 21A faces the tapered region 12B in the lamination direction. This allows the solid electrolyte layer 20 containing solid electrolyte particles having a small particle size to face the tapered region of the positive electrode layer 10 where the thickness is not uniform, and the formation of gaps between the positive electrode layer 10 (the positive electrode active material layer 12) and the solid electrolyte layer 20 can be inhibited.

As a result, in the positive electrode layer 10 (the positive electrode active material layer 12) and the solid electrolyte layer 20, a decrease in ion conductivity can be minimized.

The all-solid-state battery 1 of the present embodiment preferably utilizes a lithium deposition and dissolution reaction. In this case, the all-solid-state battery 1 of the present embodiment preferably further includes an intermediate layer 50 containing particles having a particle size of 0.5 μm or less between the solid electrolyte layer 20 and the negative electrode layer 30. When the particle size of the particles contained in the intermediate layer 50 is equal to or smaller than the upper limit value, the thickness of the intermediate layer 50 is thin, the particle size of the particles is also small, but the density of the solid electrolyte layer 20 is high, and thus the structure of the intermediate layer 50 is stable.

The particle size of the particles can be measured by particle size distribution measurement.

In addition, the solid electrolyte layer 20 preferably has an intermediate layer facing region 21B facing the intermediate layer 50 at least at the end 21 in a direction perpendicular to the direction in which the positive electrode layer 10, the solid electrolyte layer 20 and the negative electrode layer 30 are laminated. When the intermediate layer facing region 21B is provided, the thickness of the intermediate layer 50 is thin, the particle size of the particles is also small, but the density of the solid electrolyte layer 20 is high, and thus the structure of the intermediate layer 50 is stable.

The thickness of the intermediate layer 50 is preferably 2.7 μm or more and 3.3 μm or less, more preferably 1.8 μm or more and 2.2 μm or less, and still more preferably 0.9 μm or more and 1.1 μm or less. When the thickness of the intermediate layer 50 is equal to or larger than the lower limit value, this is advantageous for diffusion of lithium ions, and a rectifying effect can be expected. When the thickness of the intermediate layer 50 is equal to or smaller than the upper limit value, the resistance decreases.

The solid electrolyte layer 20 preferably has an extension part 22 that extends beyond the positive electrode layer 10 and the negative electrode layer 30 in a direction perpendicular to the direction in which the positive electrode layer 10, the solid electrolyte layer 20 and the negative electrode layer 30 are laminated. When the extension part 22 is provided, since the high-density solid electrolyte layer 20 extends outward beyond the positive electrode layer 10 and the negative electrode layer 30, the insulating properties of the positive electrode layer 10 and the negative electrode layer 30 due to the solid electrolyte layer 20 are improved.

At the outer circumferential end 21, the density of the solid electrolyte layer 20 is preferably 1.90 g/cm³ or more, more preferably 1.92 cm³ or more, and still more preferably 1.93 cm³ or more. At the outer circumferential end 21, when the density is equal to or larger than the lower limit value, the solid electrolyte layer 20 is formed over the entire outer circumference (in both the long side direction and the short side direction of the positive electrode layer 10 and the negative electrode layer 30) of the positive electrode layer 10 and the negative electrode layer 30.

In the solid electrolyte layer 20, the length (the length of the solid electrolyte layer 20 in the long side direction shown in FIG. 1) L1 on one outer circumferential side in the direction perpendicular to the lamination direction of the positive electrode layer 10, the solid electrolyte layer 20 and the negative electrode layer 30 is preferably smaller than the length (the length of the solid electrolyte layer 20 in the short side direction shown in FIG. 1) L2 on the other outer circumferential side in the direction perpendicular to the lamination direction. Thereby, the solid electrolyte layer 20 is easily formed over the entire outer circumference of the positive electrode layer 10 and the negative electrode layer 30 (in both the long side direction and the short side direction of the positive electrode layer 10 and the negative electrode layer 30).

In addition, as shown in FIG. 3, the distance d1 over a region where the density of the solid electrolyte layer 20 is 1.90 g/cm³ or more on the other outer circumferential side is preferably longer than the distance d2 over a region where the density of the solid electrolyte layer 20 is 1.90 g/cm³ or more on the one outer circumferential side. Thereby, the solid electrolyte layer 20 is easily formed over the entire outer circumference of the positive electrode layer 10 and the negative electrode layer 30 (in both the long side direction and the short side direction of the positive electrode layer 10 and the negative electrode layer 30).

The ion conductivity of the solid electrolyte layer 20 is preferably 1.00 mS/cm or more, more preferably 1.05 mS/cm or more, and still more preferably 1.10 mS/cm or more. When the ion conductivity of the solid electrolyte layer 20 is equal to or larger than the lower limit value, the solid electrolyte layer 20 has excellent ion conductivity.

The ion conductivity of the solid electrolyte layer 20 can be measured by impedance measurement.

### Positive Electrode Layer

The positive electrode layer 10 includes the positive electrode current collector 11 and the positive electrode active material layer 12. As the material of the positive electrode active material layer 12, for example, aluminum can be used. The positive electrode active material layer 12 contains a positive electrode active material.

Examples of positive electrode active materials include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), heteroelement-substituted Li—Mn spinel represented by Li₁₊ₓMn_{2-x-y}M_{y}O₄ (x+y=2, M=at least one selected from among Al, Mg, Co, Fe, Ni and Zn), lithium titanate (oxide containing Li and Ti), and lithium metal phosphate (LiMPO₄, M=at least one selected from among Fe, Mn, Co, and Ni). The positive electrode active material layer may contain various additives used as materials for the positive electrode active material layer 12 such as a binder and a conductivity aid.

### Negative Electrode Layer

The negative electrode layer 30 includes the negative electrode current collector 31 and the negative electrode active material layer 32. As the material of the negative electrode active material layer 32, for example, copper can be used. The negative electrode active material layer 32 contains a negative electrode active material. As the negative electrode active material, lithium or a metal that forms an alloy with lithium can be used. Examples of metals that form an alloy with lithium include Mg, Si, Au, Ag, In, Ge, Sn, Pb, Al and Zn. In addition, the negative electrode active material may also include a carbonaceous material. Examples of carbonaceous materials include natural graphite, artificial graphite, mesocarbon microbeads (MCMB), hard carbon and soft carbon.

### Solid Electrolyte Layer

As the solid electrolyte contained in the solid electrolyte layer 20, for example, a sulfide-based solid electrolyte can be used. Examples of sulfide-based solid electrolytes include Li₂S—P₂S₅, Li₂S—P₂S₅—LiI, Li₂S—P₂S₅—Li₂O, Li₂S—P₂S₅—Li₂O—LiI, LiS—SiS₂, Li₂S—SiS₂—Li, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (provided that m and n are a positive number, and Z is Ge, Zn, or Ga), Li₂S—GeS₂, Li₂S—SiS₂—Li₃PO₄, and Li₂S—SiS₂—LiₓMO_{y} (provided that x and y are a positive number, and M is P, Si, Ge, B, Al, Ga, or In).

### Intermediate Layer

The material constituting the intermediate layer 50 is not particularly limited.

According to the all-solid-state battery 1 of the present embodiment, in the solid electrolyte layer 20, at least at the end 21 in a direction perpendicular to the direction in which the positive electrode layer 10, the solid electrolyte layer 20 and the negative electrode layer 30 are laminated, since the contract area between the solid electrolyte particles increases, the ion conductivity of the solid electrolyte layer 20 is improved.

While the embodiments of the present invention have been described above in detail, the present invention is not limited to the above embodiments, and various modifications and changes can be made within the gist of the present invention described in the scope of claims.

### EXAMPLES

The present invention will be described below in more detail with reference to examples, but the present invention is not limited to the following examples.

### Example 1

A solid electrolyte slurry containing solid electrolyte particles having a particle size of 3 μm (hereinafter referred to as “solid electrolyte particles A”) and solid electrolyte particles having a particle size of 0.7 μm (hereinafter referred to as “solid electrolyte particles B”) was applied onto an aluminum foil, and the solid electrolyte slurry was dried to form a solid electrolyte layer containing the solid electrolyte particles A and the solid electrolyte particles B at a mass ratio of 8:2 on the aluminum foil. The obtained solid electrolyte layer was compressed at a pressure of 800 MPa to obtain a solid electrolyte layer having a density of 1.93 g/cm³ and a porosity of 0.12%.

FIG. 4 shows a scanning electron microscope (SEM) image of a cross section of the obtained solid electrolyte layer in the thickness direction. As shown in FIG. 4, it was found that the obtained solid electrolyte layer was a dense layer in which the gaps between the solid electrolyte particles A are filled with the solid electrolyte particles B.

### Example 2

A solid electrolyte slurry containing solid electrolyte particles B was applied onto an aluminum foil, and the solid electrolyte slurry was dried to form a solid electrolyte layer containing the solid electrolyte particles B on the aluminum foil. The obtained solid electrolyte layer was compressed at a pressure of 800 MPa to obtain a solid electrolyte layer having a density of 1.93 g/cm³ and a porosity of 0.10%.

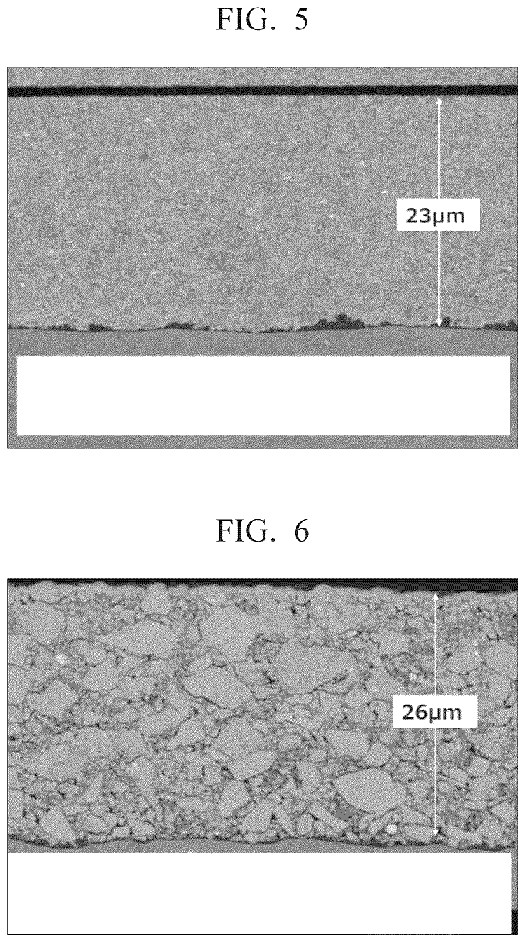

FIG. 5 shows a scanning electron microscope (SEM) image of a cross section of the obtained solid electrolyte layer in the thickness direction. As shown in FIG. 5, it was found that the obtained solid electrolyte layer was a dense layer formed of only the solid electrolyte particles B.

### Comparative Examples

A solid electrolyte slurry containing solid electrolyte particles A was applied onto an aluminum foil, and the solid electrolyte slurry was dried to form a solid electrolyte layer containing the solid electrolyte particles A on the aluminum foil. The obtained solid electrolyte layer was compressed at a pressure of 800 MPa to obtain a solid electrolyte layer having a density of 1.88 g/cm³ and a porosity of 2.57%.

FIG. 6 shows a scanning electron microscope (SEM) image of a cross section of the obtained solid electrolyte layer in the thickness direction. As shown in FIG. 6, it was found that the obtained solid electrolyte layer was not a dense layer formed of only the solid electrolyte particles B.

What is claimed is:

1. An all-solid-state battery comprising a positive electrode layer, a solid electrolyte layer, and a negative electrode layer,
wherein the solid electrolyte layer contains solid electrolyte particles having a particle size of 1 μm or less at least at an end in a direction perpendicular to the direction in which the positive electrode layer, the solid electrolyte layer and the negative electrode layer are laminated, and
the solid electrolyte layer has a density of 1.90 g/cm³ or more at least at the end in the direction perpendicular to the lamination direction.

2. The all-solid-state battery according to claim 1,
wherein the solid electrolyte layer does not contain solid electrolyte particles having a particle size of more than 1 μm at least at the end in the direction perpendicular to the lamination direction.

3. The all-solid-state battery according to claim 1, wherein the solid electrolyte layer contains a binder, and a content of the binder with respect to a total weight of the solid electrolyte layer is 3 wt % or more.

4. The all-solid-state battery according to claim 1,
wherein the solid electrolyte layer has a positive electrode facing region that faces the positive electrode layer at least at the end in the direction perpendicular to the lamination direction, and
in the solid electrolyte layer, a specific surface area of the positive electrode facing region on a side closer to the positive electrode layer is 548 m²/g or more.

5. The all-solid-state battery according to claim 1,
wherein the solid electrolyte layer has a positive electrode facing region that faces the positive electrode layer at least at the end in the direction perpendicular to the lamination direction,
the positive electrode layer has a tapered region where a thickness decreases at the end in the direction perpendicular to the lamination direction, and
the positive electrode facing region faces the tapered region in the lamination direction.

6. The all-solid-state battery according to claim 1,
wherein the all-solid-state battery utilizes a lithium deposition and dissolution reaction,
the all-solid-state battery further comprises an intermediate layer containing particles having a particle size of 0.5 μm or less between the solid electrolyte layer and the negative electrode layer, and
the solid electrolyte layer has an intermediate layer facing region that faces the intermediate layer at least at the end in the direction perpendicular to the lamination direction.

7. The all-solid-state battery according to claim 1, wherein the solid electrolyte layer has an extension part that extends beyond the positive electrode layer and the negative electrode layer in the direction perpendicular to the lamination direction.

8. The all-solid-state battery according to claim 1, wherein the solid electrolyte layer has a density of 1.90 g/cm³ or more at an outer circumferential end.

9. The all-solid-state battery according to claim 8,
wherein the solid electrolyte layer has a smaller length on one outer circumferential side in a direction perpendicular to the lamination direction than on other outer circumferential side in the direction perpendicular to the lamination direction, and
the distance over a region on the other outer circumferential side where the density of the solid electrolyte layer is 1.90 g/cm³ or more is longer than the distance over a region on the one outer circumferential side where the density of the solid electrolyte layer is 1.90 g/cm³ or more.

10. The all-solid-state battery according to claim 1, wherein the solid electrolyte layer has an ion conductivity of 1.00 mS/cm or more.
